(19) United States
(12) Patent Application Publication
(10) Pub. No.: US 2024/0354245 A1
(43) Pub. Date: Oct. 24, 2024

(54) METHOD FOR OBJECT MODEL MANAGEMENT OF AN OBJECT MODEL IN A VOLATILE WORKING MEMORY AND VEHICLE ASSISTANCE SYSTEM

(71) Applicant: Robert Bosch GmbH, Stuttgart (DE)

(72) Inventors: Andreas Markus Brodt, Gerlingen (DE); Michel Bode, Ditzingen (DE)

(21) Appl. No.: 18/589,021

(22) Filed: Feb. 27, 2024

(30) Foreign Application Priority Data
Apr. 24, 2023 (DE) 10 2023 203 754.8

(51) Int. Cl. G06F 12/02; B60W 50/00

(52) U.S. Cl. CPC G06F 12/023; B60W 50/00; B60W 2050/0005; B60W 2420/408

(57) ABSTRACT

A method for object model management for a vehicle assistance system of a vehicle. Existing real objects are sensed by at least one vehicle sensor, and, starting from sensor data of the vehicle sensor, are identified by corresponding objects of an object model managed as follows: providing a volatile working memory including a statically allocated memory array with memory array locations respectively identified by a memory array index; object insertion by storing at least one object, identifying the real object through the assigned object model, in a free memory array location of the memory array; carrying out object model actions, including at least one object iteration, on the objects with respect to the working memory, wherein at least the object iteration is carried out by using a memory allocation vector which indicates the object occupancy state of the individual memory array locations.

### CROSS REFERENCE

The present application claims the benefit under 35 U.S.C. § 119 of German Patent Application No. DE 10 2023 203 754.8 filed on Apr. 24, 2023, which is expressly incorporated herein by reference in its entirety.

### FIELD

The present invention relates to a method for object model management of an object model in a volatile working memory. Furthermore, the present invention relates to a vehicle assistance system for a vehicle.

### BACKGROUND INFORMATION

Vehicle assistance systems are experiencing increasing prevalence, for example as an adaptive cruise control, as an emergency braking assistant, or as a (semi)autonomous vehicle operation. These vehicle assistance systems typically use several different sensor systems, e.g., radar sensors, cameras, or lidar sensors. The sensor data provided by the sensors are used to create an environmental model, on the basis of which the vehicle assistance system then plans and controls actions.

Typically, vehicle assistance systems use at least one object-based environmental model, hereinafter referred to as object model, which represents the objects in the vehicle environment of the vehicle that are relevant to the vehicle assistance systems.

### SUMMARY

According to the present invention, a method for object model management of an object model in volatile working memory is provided. The object model management having features of the present invention can be carried out in a more efficient, energy-saving, and faster manner, in particular by means of fewer processor instructions to carry out the object actions.

The method can quickly release a memory array location again. The method provides a speed advantage in comparison to existing approaches, in particular by eliminating many otherwise common linear search commands by means of an object identifier. In addition, the method saves memory space by using the memory allocation vector rather than pointers or references from free space management systems with linked lists. The memory allocation vector allows for efficient free space management in order to sense the object occupancy states overall, i.e., which memory array locations are occupied or free at the time of the query.

A vehicle assistance system according to the present invention may comprise an adaptive cruise control, an emergency braking assistant, and/or a (semi)autonomous vehicle operation function.

The vehicle can be a motor vehicle, a truck, e.g., a motor vehicle comprising at least three vehicle wheels, a two-wheeled vehicle, in particular a motorcycle. The vehicle can be a robot, e.g., a robotic mower.

The sensor data can be present in the form of pixels of a camera image or measurement data of a radar sensor.

The individual object can be present in the form of digital data in the object model.

The real objects can be static objects, such as bollards, sign beacons, trees, or other obstacles. The real objects can include other vehicles, e.g., motor vehicles, trucks, two-wheeled vehicles, in particular, bicycles or motorcycles, pedestrians, or also other living beings.

Object-relevant information, e.g., an object position, an object movement direction, an object type (for example, whether static/dynamic, type of the object), a detection time, or the like, can be assigned to the objects in the object model. The object-relevant information assigned to the respective object can originate from an object recognition and/or object classification.

In particular, object model actions are understood to mean data processing actions with the objects with respect to the working memory, e.g., an object insertion into the working memory as well as an object deletion from the working memory.

The memory allocation vector may have a dimension corresponding to the number of memory array locations. The memory allocation vector may also have a dimension that is greater than the number of memory array locations.

The size of the memory array can be the same as the size of the object model, which in turn corresponds to the number of the objects.

The method according to the present invention can dispense with the use of dynamic memories (also referred to as heaps), with which contiguous memory portions of the working memory can be requested at runtime of a program and can be released again in any order. This can increase the safety of the vehicle assistance system.

In a preferred embodiment of the present invention, it is advantageous if the object iteration takes place by ascertaining, from the memory allocation vector, the respectively next memory array location occupied by an object, in the index order of the memory array index. The individual vector values of the memory allocation vector can be assigned to the memory array locations. Since the vector values can identify the object occupancy state at the assigned memory array location, the vector values of the memory allocation vector can be used to locate the next occupied or free memory array location.

A preferred embodiment of the present invention is advantageous, in which the object model actions comprise at least one object search carried out by searching for an object identifier assigned to the object. The object identifier can unambiguously identify the object.

According to an example embodiment of the present invention, the object model actions can furthermore include an object insertion and/or object deletion. In addition, within the scope of the object model actions, an object merge can consider previously separate objects, which do not necessarily have to be alternative hypotheses, i.e., assumed objects, to one another, as a single object and fuse them. For example, different parts of a large vehicle can initially be recognized as separate objects, which the object merge later converts into a single object.

The object model management should be able to efficiently implement the tasks of object iteration, i.e., iterating over all objects, of object insertion, i.e., inserting an object, of object search, i.e., finding an object by means of an object identifier, of object deletion, i.e., deleting an object on the one hand by means of the object identifier and on the other hand by means of a position in the object model. In particular, it is not necessary for a particular order to be defined in the object model. It can thus be irrelevant whether a newly inserted object is reached last in a subsequent iteration; it should in particular only be ensured that the object is reached.

If an object insertion is to insert an object, a search for a free memory array location in the memory array is in particular carried out. Object deletion can be carried out without reorganization. Object iteration can be carried out in the order of the memory array locations by processing all occupied memory array locations successively.

According to an example embodiment of the present invention, if more objects are generated than the object model can accommodate, the method can prioritize the objects. In this case, a new object O⁺ is in particular only included in the object model if it has a higher priority than the lowest-priority object Oₘᵢₙ in the object model. In this case, the method removes Oₘᵢₙ from the object model, updates, where applicable, the alternative hypotheses thereof, and inserts O⁺ in place thereof. Due to the size constraint of the object model as well, it is thus important that objects can be efficiently inserted, removed, found by means of an object identifier, and run through per object iteration.

Advantageous is a preferred embodiment of the present invention in which the object identifier contains the memory array index assigned to a memory array location at which the object comprising the object identifier is stored. As a result, the search for an object with a given object identifier is faster. The time required for the object search is constant and independent of the number of objects in the object model since each object identifier is mapped to a unique memory array index. Furthermore, a suitable hash function can be implemented, which maps the object identifiers to the respective memory array locations. The method preferably does not require any additional memory array locations, which a conventional hash table would need due to possible collisions.

In comparison to a direct pointer to the memory array location of the respective object, such an object identifier has the advantage that the realized object reference also remains valid on a copy of the object model. This is in particular significant in the case of a component architecture with shared memory communication.

If a new object is to be inserted into the object model by means of object insertion, a search for a free memory array location is carried out first. The object is subsequently stored in this memory array location. Thereafter, the object identifier of the object is changed so that the object identifier contains the memory array index of the array memory location. This means that the object does not have its object identifier until after successful object insertion.

If an object search searches for an object via the object identifier, the memory array index can be obtained from the object identifier. If the corresponding memory array location is occupied and if the object identifier of the object stored at this memory array location matches the object identifier sought, the object is found. If not, then no object with the object identifier sought exists in the object model.

According to an example embodiment of the present invention, an object can be deleted on the basis of its object identifier by means of object deletion by marking the memory array index of the array memory location at which the object to be deleted is stored as unoccupied in the memory allocation vector in a step downstream of the object search.

The memory array index in the object identifier may not be sufficient as the only identification feature. For example, the object identifier of an object that has already been deleted should not be confused with the object identifier of a new object that is now stored in the same memory array location. Further features should therefore be included in the object identifier in order to exclude such confusions as much as possible.

In a specific embodiment of the present invention, it is advantageous if the object identifier additionally has at least one counter value in addition to the memory array index. The counter values can be independent of the memory array index. That is to say, an object that is stored at a specified memory array location and replaced by another object at the same memory location has a counter value that is different from the object previously stored there.

As a result, the object identifiers are extraordinary in comparison to conventional data structures since it does require that an object identifier and thus an object is changed during insertion. This behavior can require updating all references to the object that use an object identifier that existed until then, in particular in the alternative hypotheses.

The method of the present invention provides a speed advantage in comparison to existing approaches, in particular by eliminating many otherwise common linear search commands by means of an object identifier. In addition, the method saves memory space by using a memory allocation vector rather than pointers or references from free space management systems with linked lists.

The counter values can be implemented by sequential numbers. The counter value and/or the memory array index can be a natural number. The object identifier can have a size of 4 bits, 8 bits, 16 bits, 32 bits, or greater than 32 bits.

In a preferred embodiment of the present invention, it is advantageous if the counter value is formed from a global counter value across all memory array locations, which global counter value is increased with each object insertion as an object model action. The object identifier can have first bits provided for the array memory location and second bits provided for the counter value. For example, the object identifier can have 32 bits divided into 24 bits for the counter value and 8 bits for the memory array index. The object identifier can be constructed as follows:

Counter value|memory array index, with the exemplary values 123456|21

The order of counter value and memory array index can also be reversed.

In an advantageous embodiment of the present invention, it is provided that the counter value is individually assigned to the memory array location and is only increased with an object insertion as an object model action taking place at the assigned memory array location. This counter value can be incremented when an object is stored in the memory array location. That is to say, these counter values increase much slower than a single global counter. An overflow of the counter value can thus be delayed.

When an object is stored in a memory array location, the object receives an object identifier consisting of the position-specific counter value and the memory array index. Confusion of the objects as a result of object identifiers created in this way is virtually excluded.

The position-specific counter values do not require any additional memory. When an object is stored in a memory array location, this also includes its object identifier. When an object is deleted from the object model and replaced by another one at the relevant memory array location, the object identifier of the previous object is read and its contained position-specific counter value is increased before the new object is copied to the memory array location.

Advantageous is a preferred embodiment of the present invention in which the memory allocation vector comprises, as vector values, bits that binarily identify the object occupancy state. For each memory array location, the memory allocation vector can have a bit that is assigned to the memory array index and indicates whether the memory location is occupied, i.e., the bit is 1, or not occupied and the bit is thus 0. When a new object is to be inserted, a search for a 0 bit can be carried out. If found, its memory array index can be used as a position indication for storing the object in the assigned memory array location. Concomitantly, the method also changes the value of the bit in the memory allocation vector to 1. Conversely, in an object deletion, an object is deleted from the object model and the bit of the assigned memory array location in the memory allocation vector is set to 0.

The search for a 0 bit in the memory allocation vector can take place iteratively. However, the first 0 bit of the memory allocation vector can also be ascertained with constant effort by means of specific processor instructions. The memory allocation vector can comprise several so-called machine words, i.e., bit groups, which, strung together, span the entire vector dimension of the memory allocation vector. A search for the first machine word w that does not solely consist of 1 bits can take place first. Subsequently, the bit index i_{w} of the first 0 bit in w can be ascertained and the corresponding bit can simultaneously be set to 1 in order to mark the assigned memory array location as occupied.

This process can take place by inverting w and storing it in w, i.e.,

$$w = INVERT ( w ) .$$

Subsequently, w is combined with its two's complement −w in a binary AND operation, i.e.,

$$l s b = BITAND ( w , - w ) .$$

The two's complement −w is formed by w=w+1. Thereafter, the CTZ (count trailing zeros) function can be used to count the 0 bits of lower significance than the bit previously isolated in lsb, by using

$${i}_{w} = C T Z ( l s b ) .$$

This number corresponds to the 0-based index i_{w} of the first 0 bit in w. The bit located at the position i_{w} in w can subsequently be set to the value 1 in order to mark the found memory array location directly as occupied, namely, with

$$w = BITOR ( w , lsb ) .$$

The index i of this memory array location, which is used to store the object to be inserted, corresponds to i_{w} plus the number of bits of the preceding fully occupied machine words. The INVERT, BITAND, and BITOR operations are in particular directly available as hardware instructions in all common processors and microcontrollers. If CTZ is not available, many processors have at least the CLZ (count leading zeros) function. With CLZ, CTZ can be emulated as follows:

$$CTZ ( x ) = N - 1 - CLZ ( x ) .$$

Here, N is the number of bits in a machine word, e.g., N=32. For x, it must be true that only a single 1 bit exists in x, which took place previously by isolating the least significant bit.

Yet other processors have the NORM (normalize integer) instruction. NORM returns the number of redundant sign bits of a signed integer value. That is to say, if the integer is positive (sign bit is 0), the following is true

$$NORM ( x ) = CLZ ( x ) - 1$$

In this case, CTZ can be written as follows:

$$CTZ ( x ) = N - 2 - NORM ( x )$$

If only a single 1 bit exists in x, said bit is the most significant bit. This case can be easily intercepted and treated separately:

$$CTZ ( x ) = N - 2 - NORM ( x ) if ( x ≫ 31 ) = 0 , otherwise N - 1$$

If none of the instructions CTZ, CLZ or NORM is available, CTZ can be calculated sufficiently efficiently via lookup tables or by means of divide-and-conquer approaches.

According to an example embodiment of the present invention, if the number of objects in the object model is not a multiple of the bit number N of a machine word w, for example, as with 28 objects on a 32-bit processor, the memory allocation vector comprises excess bits, here four, which do not correspond to any memory array location and must not be recognized as a free memory array location. This case can be prevented if these bits are set to 1 when the memory allocation vector is initialized. These excess bits thus appear to be occupied memory array locations and are not considered in the search for a free memory array location.

In the object iteration, the object model in particular iterates by processing all used memory array locations successively. That is to say, the object iteration can take place in the order of the memory array locations of the objects. The iteration sequence in particular exclusively takes place in a forward direction.

The memory allocation vector of the free space management system can be used for the object iteration. Here, the memory array indices of all 1 bits in the memory allocation vector can be ascertained successively, and the object at the corresponding memory array index can be output.

According to an example embodiment of the present invention, the object iteration can be carried out by means of an iterator. The iterator stores a copy wₖ of the machine word w of the memory allocation vector in which the memory array location of the currently relevant object is managed. By using the previously described function CTZ, the iterator ascertains the index i_{w}, relative to the word, of the least significant 1 bit in wₖ. The index i of the current object in the memory array corresponds to i_{w} plus the number of bits in the preceding machine words. In this respect, the iterator stores the index iᵥ of the current machine word that was copied into wₖ. The index i of the current object is subsequently stored or, if necessary, calculated.

A new iterator is initialized by referencing the first machine word of the memory allocation vector. The index of the current machine word iᵥ is 0, and wₖ is a copy of the first machine word. When the index i of the current object is stored, i=0 is initialized. If the first memory array location is occupied, i.e., if the least significant bit in wₖ is 1, the iterator is already fully initialized. If this is not the case, the iterator is advanced to the first occupied memory array location or, if the object model is empty, to the end of the machine word. For this purpose, the least significant bit in wₖ is set to 1, and the iterator is caused to make a step forward, as described below.

An iterator processes all 1 bits in wₖ until wₖ=0. If the iterator proceeds, it removes the bit corresponding to the just-visited object from wₖ and searches for the next 1 bit by means of CTZ. If this was the last 1 bit, i.e., wₖ=0 now, the iterator searches for the next non-0 machine word in the memory allocation vector. If no such machine word exists, the object iteration is ended. If it exists, the iterator updates iᵥ accordingly and copies this machine word to wₖ. As described, the iterator can subsequently calculate the index i of the next object as follows:

$$i = C T Z ( {w}_{k} ) + {i}_{v} \cdot N$$

The object iteration is ended if iᵥ or i reference a memory array index outside of the capacity of the object model. This can be accomplished if the search for the next 1 bit in wₖ identifies an excess bit, as previously described in connection with the search for a free memory array location, or if the search for the next non-empty machine word in the memory allocation vector reaches the end thereof.

According to the present invention, a vehicle assistance system is also provided. The vehicle assistance system can be designed as an embedded system. This can reduce the electrical energy demand of the vehicle assistance system. Furthermore, the heat loss can be reduced.

An embedded system is understood to be a combination of hardware and software that is incorporated within a larger system for performing at least one specified function. The embedded system can be programmable. The specified function may be variable on the embedded system or preferably unchangeably fixed.

An embedded system typically has relatively little memory and computing power. Each object in the object model requires a non-negligible amount of working memory, and computing power is needed to create, track, and update each object. For this reason, the capacity of the object model can typically be limited to a maximum size in the range of about 30 to 100 objects.

The processing unit and object model management unit can be assigned to a common processing unit. The processing unit and the object model management unit can be formed separately from one another and can be connected to one another for data transfer.

In a specific embodiment of the present invention, it is advantageous if the vehicle sensor is designed as a radar sensor and the sensor data are radar sensor data. The radar sensor can be an FMCW radar sensor. The vehicle sensor may also be a lidar or a video camera.

Further advantages and advantageous embodiments of the present invention emerge from the description of the drawings and from the drawings.

### BRIEF DESCRIPTION OF THE DRAWINGS

The present invention is described in detail below with reference to the figures.

FIG. 1 shows a vehicle assistance system and a method for object model management in a specific example embodiment of the present invention.

FIG. 2 shows a memory array of a working memory in a design according to the related art.

FIG. 3 shows a memory array of a working memory in a further design according to the related art.

FIG. 4 shows a memory array of a working memory in a specific embodiment of the present invention.

FIG. 5 shows a method for object model management in a further specific embodiment of the present invention.

### DETAILED DESCRIPTION OF EXAMPLE EMBODIMENTS

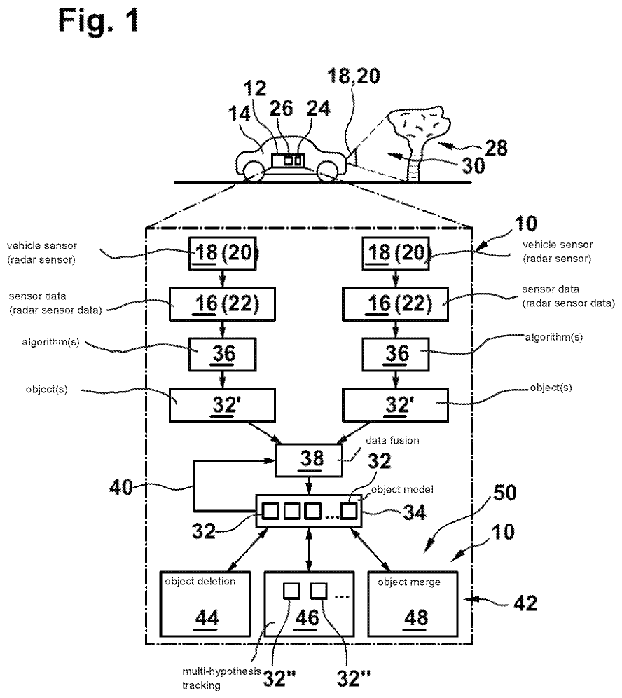

FIG. 1 shows a vehicle assistance system and a method for object model management in a specific embodiment of the present invention. The method 10 for object model management is carried out in a vehicle assistance system 12 of a vehicle 14. The vehicle 14 comprises at least one vehicle sensor 18 providing sensor data 16, in particular a radar sensor 20 outputting radar sensor data 22. The sensor data 16 can, for example, be present in the form of pixels of a camera image of a video camera or radar measurement data of the radar sensor 20. The vehicle assistance system 12 comprises a processing unit 24 for processing sensor data 16 of vehicle sensor 18 and an object model management unit 26 for the object model management of objects 32 of an object model 34 that respectively identify real objects 28 in a vehicle environment 30 of the vehicle 14.

The object model 34 comprises the (digital) objects 32 respectively assigned to the real objects 28. The object model 34 is created by processing the sensor data 16 by means of algorithms 36 that carry out an object recognition of the real object 32 in the vehicle environment 30 in a manner specific to the respective sensor type, possibly via intermediate steps such as clustering. Furthermore, the algorithms can carry out an object classification, which determines the object type of the object 32. The vehicle assistance system 12 can calculate this separately for each of its vehicle sensors 18 and can subsequently fuse the objects 32′, created by means of the algorithms, of the individual vehicle sensors 18 via a data fusion 38 to form a single object model 34.

Alternatively, and not shown here, intermediate results of various vehicle sensors can however also be previously fused together by a data fusion upstream of the algorithms and can be further processed together by the algorithms for the creation of an object model. For example, sensor data of a radar sensor are often already included in an object recognition by a video camera in order to more easily distinguish relevant real objects from non-important interference signals (for example, radar reflections of metallic manhole covers).

The object model 34 is in turn related to the object model from the previous sensing cycle, which is considered through a feedback 40. Therefrom, the vehicle assistance system 12 can deduce movements of the object 32, can check and update predictions about the behavior of the, in particular dynamic, object 32, and can finally also remove an object 32 that is no longer recognized.

Ambiguities in the object recognition can have the result that an unambiguous interpretation of the measured sensor data 16 is not possible. Several steps in the object recognition and in the data fusion 38 are based on probabilistic methods, which can produce more than one sufficiently plausible result. For example, the position data for an obstacle as a real object 28 obliquely in front of the vehicle 14 can lead to several plausible object positions of the object 32, for example due to blurred sensing. Most notably, the object classification can also assign an object 32 with a respective probability to several classes, for example with the result of 67% cyclists, 20% motorcyclists, 3% pedestrians. A typical technique of dealing with this blurring is to create a separate object 32″ in the object model 34 for each sufficiently plausible interpretation of the sensor data 16 and to mark these separate objects 32″ as alternative to one another. In order for the objects 32 to reference their alternative hypotheses, the object model 34 must assign a unique object identifier to each separate object 32″, on the basis of which object identifier the separate object 32″ can be searched for and identified. In addition, the technical implementation of the object model 34 must be capable of efficiently finding an object 32 on the basis of its object identifier.

Furthermore, in addition to the creation of the object model 34 with object insertion, i.e., the insertion of new objects 32 or separate objects 32″, various object model actions 42 for updating the object model 34 are also carried out, which are in particular necessary due to the alternative hypotheses. Thus, an object deletion 44 can take place, in which a so-called garbage collector removes objects 32 whose assumed or predicted properties, e.g., movement direction, can no longer be reproduced from the current sensor data 16. In the object deletion 44 by the garbage collector, it is important to update any alternative hypotheses so that they no longer reference the removed object 32.

By using multi-hypothesis tracking 46, it is possible to check hypotheses that are alternative to one another, i.e., separate objects 32″, and both to remove less plausible hypotheses and to fuse several sufficiently similar hypotheses to form a single object 32, or even to add new hypotheses. Here as well, the remaining alternative hypotheses must be updated.

In addition, an object merge 48 can consider previously separate objects 32″, which not necessarily have to be alternative hypotheses to one another, as a single object 32 and can fuse them. For example, various portions of a large vehicle as a real object can initially be recognized as separate objects 32″, which the object merge 48 later converts into a single object 32.

The update 50 of the object model 34 thus makes it possible to run through all objects 32, to insert new objects 32, to remove objects 32, and to find objects 32 via their object identifier.

The object model management in a working memory of the vehicle assistance system 12 plays a central role for the vehicle assistance system 12, and its runtime needed and memory consumption have a decisive influence on the performance capability of the vehicle assistance system 12.

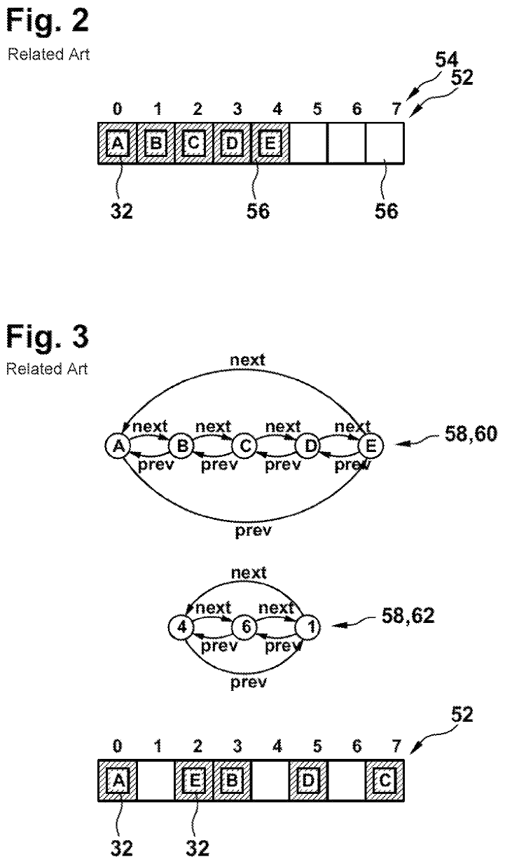

FIG. 2 shows a memory array of a working memory in a design according to the related art. The memory array 52 of the working memory 54 can be a fixed-size, statically allocated memory array 52 in which objects 32 are appended, starting at the beginning. Unused memory array locations 56 are at the end. The end of the actually used area in the memory array 52 is stored in a variable (end mark or object counter).

Iterating over all objects 32 and inserting a new object 32 are possible in an extremely efficient manner with this memory array 52. However, an object search, i.e., the search for an object 32 with a particular object identifier, requires an inefficient, linear search across all objects 32 or else a secondary search structure, which in turn consumes resources (memory and computing power for constructing and updating).

Particularly inefficient is an object deletion in which an object 32 or several objects 32 are removed from the memory array 52. Since unused memory spaces are only allowed at the end of the memory array 52, objects 32 must thus be moved to avoid a gap. If, in the example shown, the object B were deleted, the object E would have to be moved from index 4 to index 1. If an object 32 is to be deleted on the basis of its object identifier, the search effort required for this purpose is added.

FIG. 3 shows a memory array of a working memory in a further design according to the related art. A further possibility of memory management for a memory array 52 consists in storing the objects 32 in the memory array 52 with the possibility of allowing free spaces anywhere. However, memory management of free and occupied spaces is then required. This can take place in the form of two doubly linked lists 58.

In reality, the objects 32 are still in a fixed-size, statically allocated memory array 52, along with a respective reference (array index) to a successor (next) and a predecessor (prev). With the help of these references, two doubly linked lists 58 are now formed at the logical level: An object list 60 of the objects 32 of the object model and a free memory list 62. Depending on the approach, the memory array 52 along with free memory list 62 can also be referred to as an allocator. It is important to understand that the order of the list elements is completely independent of the memory array indices. The list orders result from the insertion and deletion operations performed on the lists 58.

Initially, the object list 60 is empty and the free memory list 62 contains all memory locations of the memory array 52. Whenever a new object 32 is to be inserted into the object list 60, the first element of the free memory list 62 is removed therefrom and transferred to the object list 60. When deleting from the object list 60 at any location, it is likewise only necessary to change the prev and next references such that the object 32 is again added to the free memory list 62.

The approach with the doubly linked list 58 with memory-array-based allocator is capable of inserting objects 32 into the object model and deleting them with constant effort. An iteration over the objects 32 takes place via the next references of the linked list 58. In addition, it is possible to iterate backward and to insert objects 32 anywhere. These properties, which are still advantageous in the object deletion, are however disadvantageous in the object search, i.e., the allocation of the object 32 in the memory array 52 on the basis of the object identifier.

The object 32 can be found on the basis of the object identifier with the omission of secondary search structures only by means of iteration via the object list 60, i.e., with linear effort. However, the object search required for multi-hypothesis tracking or the object merge is quite often carried out during operation of the vehicle assistance system, as is the object deletion on the basis of the object identifier, which also requires a linear search. Such linear searches however cause a considerable amount of effort in the object model management.

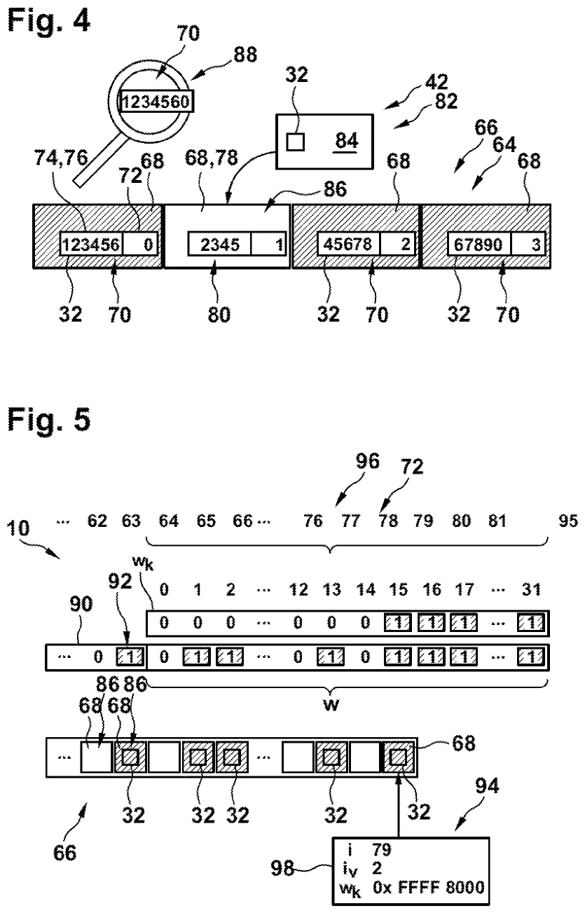

FIG. 4 shows a memory array of a working memory in a specific embodiment of the present invention. The memory array 64 of the working memory 66 is shown here, by way of example, in excerpts with four memory array locations 68. An object 32 with the indicated object identifier 70 is respectively stored at three of the four memory array locations 68. The object identifier 70 contains a memory array index 72 assigned to the memory array location 68 where the object 32 having the object identifier 70 is stored. For example, the first memory array location 68 shown here has the memory array index 72 of 0.

In addition to the memory array index 72, the object identifier 70 additionally has at least one counter value 74. For example, the first object identifier 70 has the counter value 74 of 123456. The counter value 74 can be formed from a global counter across all array memory locations, which global counter is increased with each object insertion as an object model action. Alternatively, and as shown here, the counter value 74 can be individually assigned as a position-specific counter value 76 to the array memory location. That is to say, the first memory array location 68 has a position-specific counter value 74 independent of the second memory array location 68. The position-specific counter value 74 of a memory array location 68 is increased with an object insertion, and only with an object insertion as an object model action taking place at the assigned memory array location 68.

If, by means of an object deletion, an object 32 is deleted from the object model and replaced by another one at the relevant memory array location 68, the object identifier 70 of the previous object is read and its contained position-specific counter value 76 is increased before the new object 32 is copied to the memory array location 68.

The empty memory array location 78 also has an identifier 80 in order, in an object insertion 82 by storing 84 an object 32 to be added in this memory array location 68, to read the identifier 80 assigned to this memory array location 68 and assign it to the object 32 to be added. The object occupancy state 86 of this memory array location 68 thus changes by the object insertion 82.

The object model actions 42 can include at least one object search 88, which is carried out by searching for an object identifier 70 assigned to the object 32. Since the memory array index 72 is part of the object identifier 70, the object 32 can be located directly in the memory array 64.

FIG. 5 shows a method for object model management in a further specific embodiment of the present invention. The working memory 66 in particular comprises 80 memory array locations 68 with the memory array indices from i=0 to i=79. The method 10 uses a memory allocation vector 90 that indicates the object occupancy state 86 of the individual memory array locations 68. The memory allocation vector 90 has, as vector values 92, bits that binarily identify the object occupancy state 86.

The method 10 is explained using the example of an object model capacity of 80 objects on a 32-bit processor. The memory allocation vector 90 for free memory management consists of three machine words w of 32 bits each, which overall contain 96 bits. This results in 96−80=16 excess bits in the memory allocation vector 90, i.e., bit 16 to bit 31 in the last machine word of the bit vector, which were initialized with the value 1.

In this example, an object iteration 94 is shown. The object iteration 94 takes place by ascertaining, from the memory allocation vector 90, the respectively next memory array location 68 occupied by an object 32, in the index order 96 of the memory array index 72. The iterator 98 used in the object iteration 94 currently references the last object 32 located in the memory array location 68 with the memory array index i=79. With wₖ, the iterator 98 comprises a copy of the third and thus last machine word of the memory allocation vector 90. However, the iterator 98 has already removed all 1 bits from wₖ that correspond to the position of an object 32 that has already been visited. Currently, wₖ has the value 0x FFFF 8000, which means that, besides bits 16 to 31, bit 15 also still contains the value 1 since said bit references the array index i=79 as an occupied memory array location 68. In order to now allow the iterator 98 to progress, the following steps are carried out:

1. The iterator 98 changes bit 15 in wₖ from 1 to 0 so that wₖ=0x FFFF 0000. The least significant 1 bit in wₖ, bit 16, is now an excess bit.

2. The iterator 98 checks whether wₖ=0. If this were the case, the iterator 98 would search for the next non-0 machine word in the memory allocation vector 90. Such a machine word does not exist in the present case, i.e., the iterator 98 would have reached the end.

3. However, wₖ≠0 so that the iterator 98 calculates the next memory array index 72 as follows:

$$i = CTZ ( {w}_{k} ) + {i}_{v} \cdot N = CTZ ( 0 \times FFFF 0000 ) + 2 \cdot 32 = 80$$

4. Since i=80 is not a valid memory array index 72, the object iteration 94 is terminated.

What is claimed is:

1. A method for object model management for a vehicle assistance system of a vehicle, in a vehicle environment of which existing real objects are sensed by at least one vehicle sensor and, starting from sensor data of the vehicle sensor, are identified by corresponding objects of an object model managed as follows:
providing a volatile working memory including a statically allocated memory array with a plurality of memory array locations respectively identified by a memory array index;
inserting an object by storing at least one object identifying the real object through the object model, in a free memory array location of the memory array, whereby an object occupancy state of the memory array location into which the at least one object was stored changes in comparison to the memory array location prior to the storage of the at least one object; and
carrying out object model actions, including at least one object iteration, on the objects with respect to the working memory;
wherein at least the object iteration is carried out by using a memory allocation vector which indicates an object occupancy state of each of the memory array locations.

2. The method according to claim 1, wherein the object iteration takes place by ascertaining, from the memory allocation vector, a respectively next memory array location occupied by an object, in an index order of the memory array index.

3. The method according to claim 1, wherein the object model actions include at least one object search carried out by searching for an object identifier assigned to the object.

4. The method according to claim 3, wherein the object identifier contains the memory array index assigned to a memory array location at which the object having the object identifier is stored.

5. The method according to claim 4, wherein, in addition to the memory array index, the object identifier additionally includes at least one counter value.

6. The method according to claim 5, wherein the counter value is formed from a global counter value across all of the memory array locations, the global counter value being increased with each object insertion as an object model action.

7. The method according to claim 5, wherein the counter value is individually assigned to the memory array location and is increased only with an object insertion as an object model action taking place at the assigned memory array location.

8. The method according to claim 1, wherein the memory allocation vector includes, as vector values, bits that binarily identify the object occupancy state.

9. A vehicle assistance system for a vehicle, comprising:
at least one vehicle sensor configured to sense real objects in a vehicle environment of the vehicle;
a processing unit configured to process sensor data of the vehicle sensor; and
an object model management unit for object model management of an object model identifying the real objects by corresponding objects, object model management unit configured to:
provide a volatile working memory including a statically allocated memory array with a plurality of memory array locations respectively identified by a memory array index;
insert an object by storing at least one object identifying the real object through the object model, in a free memory array location of the memory array, whereby an object occupancy state of the memory array location into which the at least one object is stored changes in comparison to the memory array location prior to the storage of the at least one object; and
carry out object model actions, including at least one object iteration, on the objects with respect to the working memory;
wherein at least the object iteration is carried out by using a memory allocation vector which indicates an object occupancy state of each of the memory array locations.

10. The vehicle assistance system according to claim 9, wherein the vehicle sensor is a radar sensor and the sensor data are radar sensor data.
